(19) United States
(12) Patent Application Publication
(10) Pub. No.: US 2007/0109917 A1
(43) Pub. Date: May 17, 2007

(54) Method and apparatus for changing mode in a portable terminal using timer

(75) Inventors: Tae-Won Um, Seoul (KR); Jung-Yeob Oh, Geongnam-si (KR); Byeong-Cheol Hwang, Seoul (KR); Hyun-Kyung Shin, Seoul (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/600,393

(22) Filed: Nov. 16, 2006

(30) Foreign Application Priority Data
Nov. 17, 2005 (KR) 2005-0110205

(51) Int. Cl. G04C 21/00

(52) U.S. Cl. 368/73

(57) ABSTRACT

Provided are a method and an apparatus for automatically changing time-setting mode in a portable terminal using a timer. The method for changing a mode in a portable terminal having a timer includes the steps of displaying a time-setting mode and setting the timer of at least one mode with a time period by selecting and time setting at least one mode in the time setting mode.

### PRIORITY

This application claims priority under 35 U.S.C. § 119 to an application entitled “Method And Apparatus For Changing Mode in Portable terminal Using Timer” filed in the Korean Intellectual Property Office on Nov. 17, 2005 and assigned Serial No. 2005-110205, the contents of which are incorporated herein by reference.

### BACKGROUND OF THE INVENTION

1. Field of the Invention

The present invention relates generally to a method and apparatus for changing a mode in a portable terminal, and in particular, to a method for automatically changing a mode in a portable terminal according to a time schedule.

2. Description of the Related Art

Portable terminals have a variety of functions that users can selectively execute. Portable terminals also provide menu items corresponding to the respective functions such that users can selectively execute the functions. Depending on the characteristics of the corresponding function, each of the menu items can have sub-menu items wherein the sub-menu items can further have detailed sub-menu items. That is, the menu generally includes a plurality of menu items that are organized in a tree-like structure.

For example, portable terminals provide a menu for setting modes (, a mode be a type of sub-menu) including a manner mode, a ring mode, and a vibration/ring mode. A user of the portable terminal manually selects a menu item to change the mode setting. That is, when a user does not select and change a menu item, a preset menu item remains unchanged. It is inconvenient for a user to manually change the menu item and moreover, in some environments, it is difficult to change.

In order to solve the above problems, a method to use a timer has been provided. That is, the user can change a set mode to a desired mode when the timer notices the set time. However, this method is problematic because the setting and operating states of the timer have to be checked and one of a volume key and a keypad of the portable terminal has to be manually used for setting the timer.

Therefore, a method and an apparatus are required for automatically changing a set mode using a timer, for visually identifying the setting and operating states of a timer, and for setting the set mode together with the set time mode of a timer in a portable terminal having a touch pad using a touch-screen technology.

### SUMMARY OF THE INVENTION

An object of the present invention is to substantially solve at least the above problems and/or disadvantages and to provide at least the advantages described herein below. Accordingly, an aspect of the present invention is to provide a method and an apparatus for automatically changing mode setting in a portable terminal.

Another aspect of the present invention is to provide a method and an apparatus for setting a timer to automatically change mode setting in a portable terminal.

A further aspect of the present invention is to provide a method and an apparatus for visually identifying the setting and operating states of a timer in a portable terminal.

According to an aspect of the present invention, a method for changing a mode in a portable terminal having a timer includes displaying a time-setting mode and setting the timer of at least one mode with a time period by selecting and time setting at least one mode in the time setting mode.

According to another aspect of the present invention, a portable terminal having a timer for changing a mode includes a display means for displaying a time-setting mode and a controller for setting the timer of at least one mode with a time period by selecting and time setting at least one mode in the time setting mode.

### BRIEF DESCRIPTION OF THE DRAWINGS

The above and other objects, features, and advantages of the present invention will become more apparent from the following Detailed Description when taken in conjunction with the accompanying drawings in which:

FIG. 1 is a block diagram illustrating a portable terminal according to the present invention;

FIG. 2A is a view of a screen illustrating a time-setting mode for setting the timer of at least one mode with a time period according to the present invention;

FIG. 2B is a view of a screen illustrating a set timer and two time-setting modes according to the present invention; FIG. 2C is a view of a screen illustrating a screen for changing a time-setting mode during an operation of a set timer according to the present invention;

FIG. 2D is a view of a screen illustrating a screen that is displayed when an operation of a set timer is completed according to the present invention;

FIG. 2E is a view of a screen illustrating a screen displaying a mode menu according to the present invention; and

FIG. 3 is a flowchart illustrating a procedure for changing a time-setting mode in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail so as not to obscure the present invention in unnecessary detail.

In the following description, a first mode is a mode that is executed at the start of the operation of a timer, and a second mode is a mode to be executed after termination of the first mode.

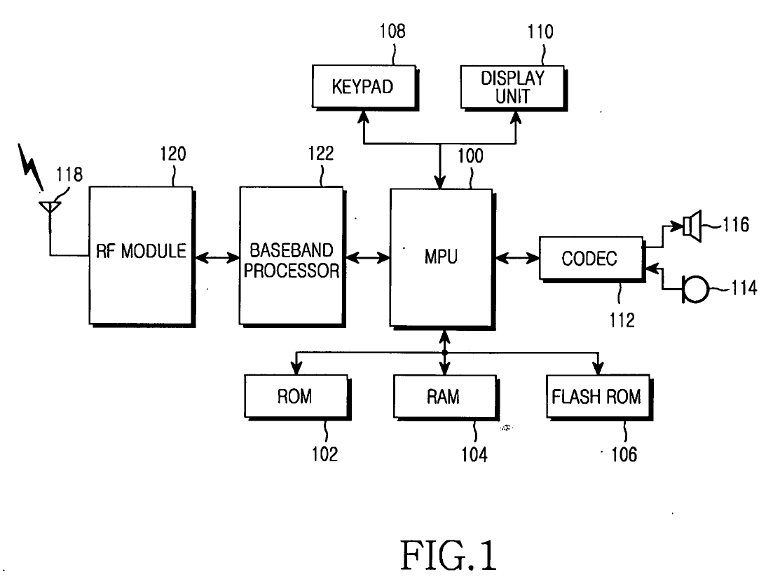

FIG. 1 is a block diagram illustrating a portable terminal according to the present invention. A portable terminal described herein below includes, but is not limited to, a cellular phone, a Personal Communication System (PCS) terminal, a Personal Data Assistant (PDA) terminal and an International Mobile Communication-2000 (IMT-2000) terminal. The following descriptions will be made with a general structure of the above terminals.

Referring to FIG. 1, the portable terminal includes a controller (e.g., a Micro Processing Unit (MPU)) 100, a Read Only Memory (ROM) 102, a Random Access Memory (RAM) 104, a Flash ROM 106, a keypad 108, a display unit 110, a coder-decoder (CODEC) 112, a microphone 114, a speaker 116, an antenna 118, a Radio Frequency (RF) module 120, and a baseband processor 122.

The controller 100 controls an overall operation of the portable terminal. For example, the controller 100 processes and controls voice communication and data communication. In addition to the general functions, the controller 100 performs a control process of setting the timer of at least one mode with a time period by selecting and time setting at least one mode in a time setting mode upon the occurrence of a timer setting event. The step of setting includes a function to display a message for notifying the future termination of the operation of the timer at a present time , and further includes a function to reset the mode upon displaying the message notifying of the future termination of the operation of the timer is displayed. The time setting is executed by touching touch elements of a touch screen in a display means or by pressing keybuttons of a keypad. A detailed description about the general control operation of the controller 100 will be omitted for conciseness.

The ROM 102 stores a variety of reference data and micro codes of a program for the process and control operation of the controller 100. The RAM 104 is a working memory of the controller 100, which stores temporary data that are generated during the execution of various programs. The Flash ROM 106 stores a variety of updatable data such as a phone book, an outgoing message, and an incoming message.

The keypad 108 includes numeric keybuttons of digits 0-9 and a plurality of function keybuttons, such as a Menu keybutton, a Cancel (Delete) keybutton, a Confirmation keybutton, a Talk keybutton, an End key button, an Internet Connection keybutton, Navigation keybuttons (▴/▾/ [symbol] / [symbol] ), and a Character Input keybutton. The keypad 108 provides the controller 100 with key input data that corresponds to a keybutton pressed by a user.

Touch screen (not shown) has touch elements corresponding to keybuttons of the keypad 108. Touch screen is located in the display unit 110.

The display unit (or called ‘means’) 110 displays status information generated during operations, numerals and characters, moving pictures and still pictures, stored data and so on. The display unit 110A can be a color Liquid Crystal Display (LCD).

The CODEC 112 which is connected to the controller 100, together with the speaker 116 and the microphone 114 that are connected to the CODEC 112 constitute an audio input/output block that is used for a telephone communication and voice recording. The CODEC 112 converts Pulse Code Modulation (PCM) data received from the controller 100 into analog audio signals and outputs the analog audio signals to the speaker 116. Also, the CODEC 112 converts audio signals received through the microphone 114 into PCM data and provides the PCM data to the controller 100.

The RF module 120 down-converts an RF signal received through the antenna 118 and provides the resulting baseband signal to a baseband processor 122. Also, the RF module 120 up-converts a baseband signal provided from the baseband processor 122 and transmits the resulting RF signal through the antenna 118. The baseband processor 122 processes the baseband signals that are exchanged between the RF module 120 and the controller 100. For example, in the case of data transmission, the baseband processor 122 performs channel coding and spreading on data to be transmitted. In the case of data reception, the baseband processor 122 performs despreading and channel decoding on received data.

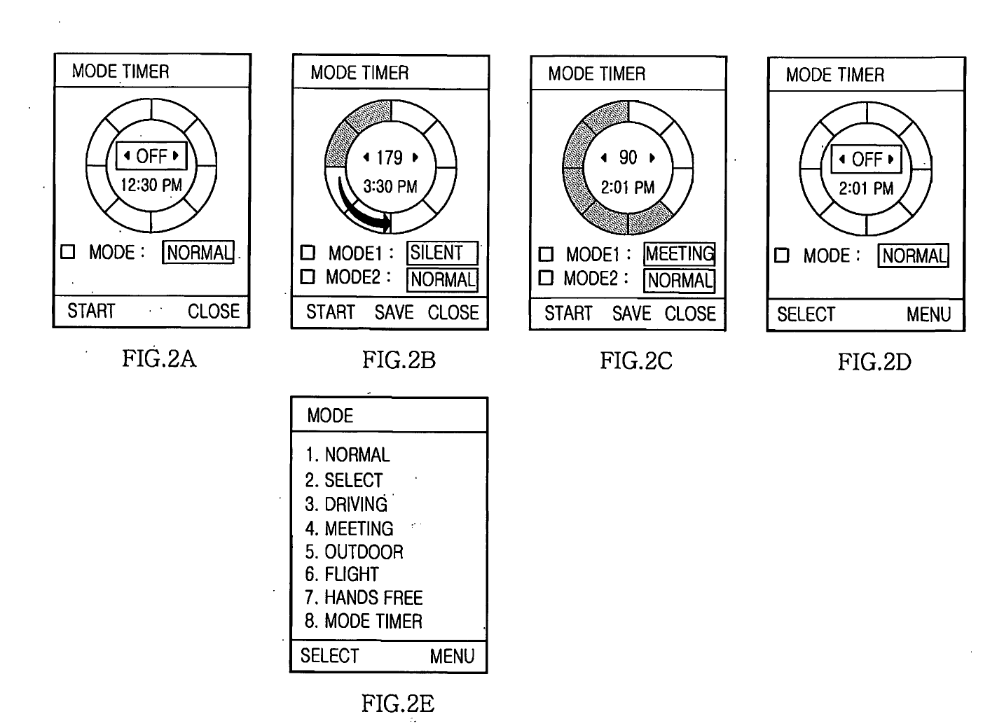

FIG. 2A is a view of a screen illustrating a time-setting mode for setting the timer of at least one mode with a time period according to the present invention.

Referring to FIG. 2A, the screen includes a circular diagram (e.g., a donut-shaped diagram), and a mode setting section. The circular diagram is displayed at a central position of the time-setting mode screen. A current time indicating section and a set time indicating section for displaying countdown of the set time of the timer are displayed in the circular diagram. The mode setting section is displayed under the circular diagram. The second mode section (not shown) can be implemented below the mode section. However, the circular diagram, the set time indicating section, the current time indicating section and the mode setting section are not limited to the above configurations and arrangements. A circular diagram can be implemented using touch-screen technology.

For example, the time-setting mode screen is touched to input the setting time of the timer. For instance, when the timer needs to be set for a user to attend a conference, the first mode is set to a silent mode for maintaining silence during the conference. When an expected meeting time is 180 minutes, the set time is set to 180 minutes. Also, the second mode is set to a ring mode that is a normal mode.

FIG. 2B is a view or a screen illustrating a set timer and two time-setting modes according to the present invention.

Referring to FIG. 2B, the screen includes a mode 1 indicating the first mode and a mode 2 indicating the second mode. Here, the first mode is silent mode and the second mode is normal mode. As described herein above, the first mode is the mode that is executed at the start of the operation of the timer, and the second mode is the mode that is executed upon termination of the first mode. When the timer starts operating, a current time changes to a setting time (for example: 3:30PM). At this point, the circular diagram displays the remaining time of the first mode. Additionally, sections of the circular diagram can change in color or shade with the proceeding time of the first mode to display the proceeding state of the first mode.

That is, during the operation of the timer, the sections for the first mode are changed in color or shade to display the elapse of the set time. Also, when one minute of the set time is left, the portable terminal displays a screen for notifying of the future termination of the operation of the timer and resetting the time-setting setting.

FIG. 2C is a view of a screen illustrating a screen for changing a time-setting mode during an operation of a set timer according to the present invention. Referring to FIG. 2C, the screen displays a first mode, a second mode, and a setting time that are newly set. In the proceeding of the first mode, user can reset the mode according to the given situation. Here, the change occurs at 12:31 PM for first mode being changed to meeting mode for 90 minutes and a second mode being changed to a normal mode.

FIG. 2D is a view of a screen illustrating a screen that is displayed when an operation of a set timer is completed according to the present invention. The first mode ends at 2:01 P.M. and the remaining mode is normal mode, which is originally set to the second mode. When the resetting is not needed, the portable terminal ends the operation of the timer and switches the mode to the ring mode (i.e., the second mode). The portable terminal displays the elapse of the set time of the first mode using the circular diagram that includes a plurality of sections for representing the elapse of the set time.

FIG. 2E is a view or a screen illustrating a screen displaying a mode menu according to the present invention. Referring to FIG. 2E, a mode in the list of the mode menu can be selected by one of a touching touch element of the touch screen in the display means and pressing corresponding keybuttons of the keypad.

As described herein above, the timer of FIGS. 2A to 2E is used for automatically changing time-setting mode in the portable terminal.

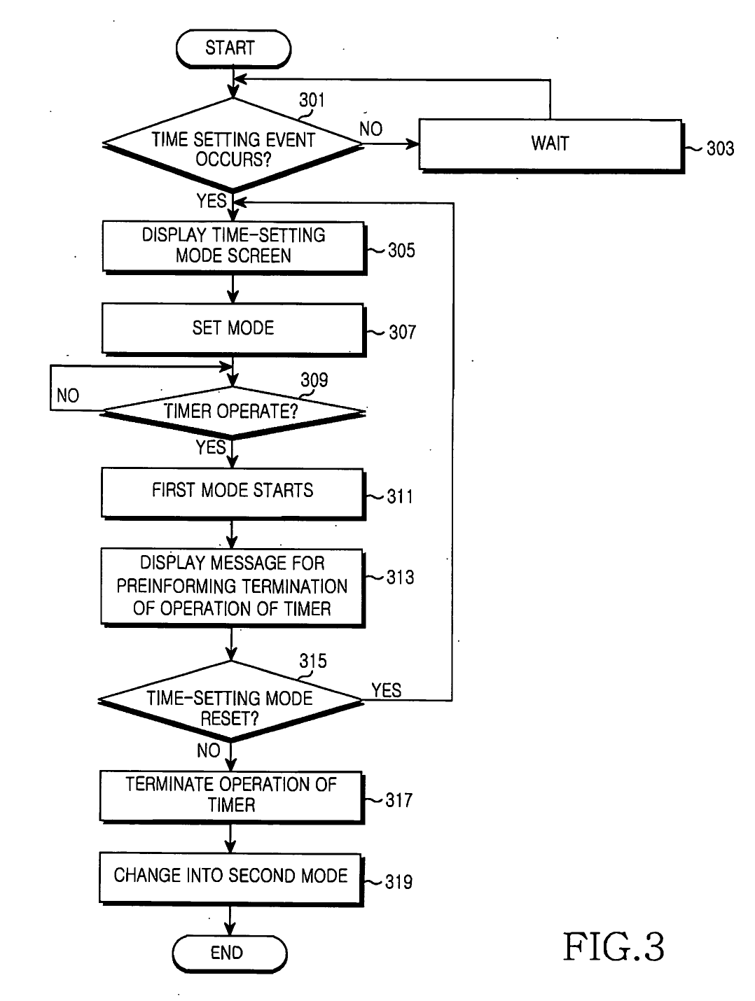

Hereinafter, a method for automatically changing time-setting mode in the portable terminal using the timer will be described in detail with reference to FIG. 3. FIG. 3 is a flowchart illustrating a procedure for changing a time-setting mode in a portable terminal according to the present invention.

Referring to FIG. 3, in step 301, the portable terminal determines whether a time-setting event occurs. However, if a time setting event does not occur, the portable terminal proceeds to step 303.In step 303, the portable terminal waits for a predetermined time and then performs step 301 again.

If a time setting event occurs, the portable terminal proceeds to step 305. In step 305, the portable terminal displays the time-setting mode screen for setting the timer. The time-setting mode screen uses the circular diagram to display a current time and a set time.

In step 307, setting of a first and a second time-setting mode is performed using a keypad, a volume key or a touch screen that are included in the portable terminal. In step 309, the portable terminal determines whether the timer starts to operate according to a set mode and a set time that are set in step 307. If the timer does not start to operate, the portable terminal performs step 309 again.

However, if the timer starts to operate, the portable terminal proceeds to step 31. In step 311, the portable terminal starts the first mode. As described herein above, the first mode performs at the start of the operation of the timer.

In step 313, the portable terminal displays a message for preinforming the termination of the operation of the timer when a predetermined portion of the set time is left. In step 315, the portable terminal determines whether the time-setting mode is reset. If the time-setting mode needs to be reset, the portable terminal returns to step 305, and if not, the portable terminal proceeds to step 317. In step 317, the portable terminal terminates the operation of the timer.

In step 319, the portable terminal switches form the first mode to the second mode. As described above herein, the second mode is a mode that is to be executed after the termination of the operation of the timer. Thereafter, the portable terminal terminates the procedure.

As described above herein, a timer function of the portable terminal is used to change the set mode with time. The time-dependent mode setting screen including the circular diagram is used to set and display the current time, the set time of the timer, the first mode, and the second mode, thereby making it possible to ascertain the time-dependent mode setting state. Also, the sections of the circular diagram are changed in color or shade, thereby making it possible to ascertain the proceeding state of the first mode. Also, the touch-screen technology can be used to conveniently perform the mode setting and the timer setting on the time-setting mode setting screen.

Preferred embodiments of the present invention can also include computer readable codes on a computer readable medium. The computer readable medium can include any data storage device that can store data readable by a computer system. Examples of a computer readable medium include magnetic storage media (e.g., ROM, floppy disks, hard disks, etc.), optical recording media (e.g., CD-ROMs, or DVDs), and storage mechanisms such as carrier waves (e.g., transmission through the Internet). The computer readable medium can also be distributed over network coupled computer systems so that the computer readable code is stored and executed in a distributed fashion. Programmers of ordinary skill in the art to which the present invention pertains can also construe functional programs, codes, and code segments for accomplishing of the present invention.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for changing a mode in a portable terminal having a timer comprising the steps of:
displaying a time-setting mode; and
setting the timer of at least one mode with a time period by selecting and time setting at least one mode in the time setting mode.

2. The method of claim 1, wherein the step of setting includes a function to display a message for notifying of the future termination of the operation of the timer at present time

3. The method of claim 2, wherein the step of setting further includes a function to reset the mode upon displaying when the message for notifying of the future termination of the operation of the timer

4. The method of claim 1, wherein the time-setting mode displays a time setting area, a mode area and a present time.

5. The method of claim 1, wherein the step of setting is performed by one of a touching touch elements of a touch screen in a display means and pressing key buttons of a keypad.

6. The method of claim 1, further comprising displaying the timer of at least one mode including a circular diagram having a plurality of sections for displaying the elapse of the set time.

7. A portable terminal having a timer for changing a mode comprising:
a display means for displaying a time-setting mode; and
a controller for setting the timer of at least one mode with a time period by selecting and time setting at least one mode in the time setting mode.

8. The portable terminal of claim 7, wherein the step of setting by the controller includes a function to display a message for notifying of the future termination of the operation of the timer at a preset time.

9. The portable terminal of claim 8, wherein the step of setting by the controller further comprises a function to reset the mode upon displaying the message for notifying of preinforming the future termination of the operation of the timer

10. The portable terminal of claim 7, wherein the time-setting mode displays a time setting area, a mode area and a present time.

11. The portable terminal of claim 7, wherein the step of setting by the controller is performed by one of a touching touch elements of a touch screen in a display means and pressing key buttons of a keypad.

12. The portable terminal of claim 7, wherein the controller further performs displays the timer of at least one mode including a circular diagram having a plurality of sections for displaying the elapse of the set time.

13. A computer-readable recording medium having recorded thereon a program for changing a mode in a portable terminal having a timer, comprising:
a first code segment for displaying a time-setting mode; and
a second code segment for setting the timer of at least one mode with a time period by selecting and time setting at least one mode in the time setting mode.
